(19) United States
(12) Patent Application Publication
(10) Pub. No.: US 2005/0100434 A1
(43) Pub. Date: May 12, 2005

(54) Multiple-picker system for media handling and other equipment

(76) Inventor: Zoltan Filep, Turlock, CA (US)

Correspondence Address: ZOLTAN FILEP, 300 WILEY CT., TURLOCK, CA, 95380, US

(21) Appl. No.: 10/964,116

(22) Filed: Oct. 13, 2004

Related U.S. Application Data
(60) Provisional application No. 60/510,434, filed on Oct. 14, 2003.

(51) Int. Cl. B25J 15/10

(52) U.S. Cl. 414/796; 294/97; 414/789.9

(57) ABSTRACT

What is new in this invention, it is the simultaneous handling of multiple work pieces during cycles of loading and unloading, making repeated movements to the loading and unloading positions from the one-by-one method unnecessary and speeding up considerably the robotic cycle. It can pick and place, as needed, a stack of ‘n’ work pieces; it can also place them one by one into position, or, if needed, it can also handle only one work piece, by example for corrections. It can also pick up ‘n’ work pieces—one by one—and store them temporarily on its stack shaft. During a cycle, it can also interrupt the cycle, store a number of ‘x’ work pieces, where ‘x’ is a number between 0 and ‘n-1’, and can handle only one work piece, as needed. All these features were impossible with the single-piece picker.

### REFERENCES CITED

U.S. Patent Documents

| | | | |
|---|---|---|---|
| 4,132,443 | January 1979 | Timberlake et al. | 294/97 |
| 5,000,651 | March 1991 | Akagawa et al. | 204/192.12 |
| 5,195,794 | March 1993 | Hummel, Jr. et al. | 294/94 |
| 5,669,652 | September 1997 | Reising et al. | 294/97 |
| 5,713,618 | February 1998 | Kocsis | 294/93 |
| 5,873,692 | February 1999 | Costas | 414/796.9 |

### BACKGROUND OF THE INVENTION

Media handling equipments' most used and maybe sophisticated assembly is the picker assembly, which actually is coming in direct contact to the media, making the physical connection between the subject of manipulation and the rest of the handling equipment. Until now, these pickers were designed to handle one single media at a time. The big inconvenient was low productivity, too many additional motions of the robotics, due insufficient efficiency of the picker.

With the increase of the recording speed and number of recording units incorporated in the same equipment, while before the robotics was waiting after the recording, now is getting there, that the recording is waiting after the robotics, especially due to inefficiency of the picker. Elimination of unnecessary motions, by increasing the efficiency of the picker, results in shorter robotics cycles and increased productivity of the whole equipment.

In the prior art, once the work-piece has been picked up from the input bin, the robotic is accessing the recording drive or loading platen and the work-piece is loaded into it. Then, the robotic is accessing again the input bin, picking up the next work-piece and loading it into the next drive or loading platen.

The repeated accessing of the input/output bins was increasing significantly the robotics cycle, slowing production down considerably.

In other industrial use—like in wafer processing, by example—there are the same productivity and efficiency increase needs.

### SUMMARY OF THE INVENTION

The invention is directed to increase the efficiency of single-piece pickers and it applies to the most already existent or even future single-piece pickers. It applies to all picking systems, where the work-piece has been picked up as a single-piece or from a stack of work-pieces.

The multiple picker system has the ability to pick the work-pieces up and to store them until processing in a LIFO (Last In/First Out) work-stack in/on the stack-shaft of the picker.

The work-pieces are loaded at once into the picker's stack shaft, than released one by one into the recording drives or loading platen, eliminating the unnecessary motions to the input bins and back.

Also, when the drives or loading platen are loaded with processed/recorded media, the multiple picker is picking them up one by one, storing them temporarily on the stack shaft, than the picker goes to the output bin and releases them all.

The multiple picker systems subdivide in 2 major groups, into internal multiple picker systems and external multiple picker system, depending on the gripping style of the work-pieces, which can be internally—thru an existing hub on the work piece—or externally—around the external perimeter—of the work-pieces.

Optionally, the multiple picker system also can be used as a single-piece picker too.

As follows, it will be described, as an example, a direct application of the invention in the CD/DVD processing robotics.

The invention, the multiple-media picker system, consists of a primary retaining system and a secondary retaining system of the media. They are controlled and activated in a manner, which allows them to handle, as needed, simultaneously more than one media. Usually, but not necessarily, the number of recording units determines the number of media needed to be handled simultaneously. So, an ‘n’ recording unit equipment needs to handle ‘n’ media simultaneously. The picker has to be able to:
1. clear the recording units from the recorded media, one by one, without going each time to the output bin;
2. to take the stack of ‘n’ recorded media to the output bin and release them;
3. to go to the input bin and to pick up ‘n’ unrecorded media;
4. to go to the recording units or a simultaneous loader arm and release the media one by one, each into his position.
5. if necessary, to be able to make corrections, by being able to handle one single piece
   The invention applies to most of the already existent pickers, and it consist in the axial mounting of 2 retaining mechanism, one in top of the other, creating a double retain-release mechanism, the primary one used to retain a stack of ‘x’ media, and the secondary one used to retain the stack of ‘x-1’ media, as needed, by example while the last, the number ‘x’ media, is processed. The number ‘x’ is variable and it decrements from ‘n’ to 0 during a complete machine cycle.

### BRIEF DESCRIPTION OF THE DRAWINGS

FIG. 1 multiple picker assembly 100, as an application of the invention to U.S. Pat. Nos. 4,132,443, 5,669,652, 5,713,618, 5,873,692, or similar, representing the main components of the internal picker.

FIG. 2 multiple picker assembly 100, as an application of the invention to U.S. Pat. Nos. 5,000,651, 5,195,794, or similar, representing the internal picker.

FIG. 3 multiple picker assembly 100, as a theoretical version of FIG. 1 and FIG. 2, representing the stack of ‘x’ media and the internal picker.

FIG. 4 multiple picker assembly 100, as a 6×1 external picker configuration, with 6 arms and each arm with 1 grip.

FIG. 5 multiple picker assembly 100, as a 3×2 external picker configuration, with 3 arms and each arm with 2 grips.

FIG. 6 multiple picker assembly 100, as a more detailed version of FIG. 1.

FIG. 7 is a system drawing of use of a multiple picker system in a CD/DVD recording robot.

### DETAILED DESCRIPTION OF THE INVENTION

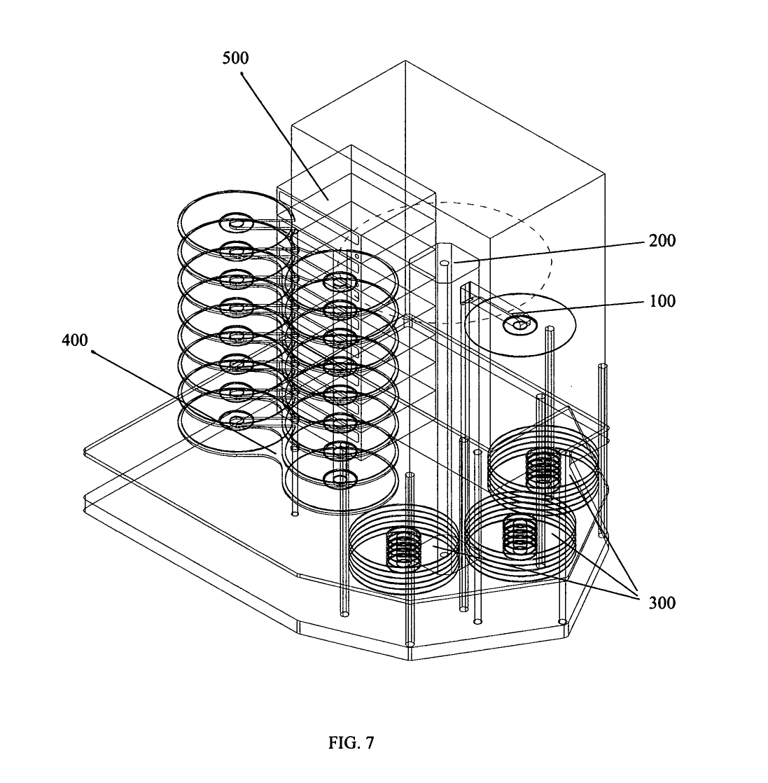

In system drawing FIG. 7:
100—multiple picker assembly
200—tower-carriage assembly
300—input/output bins for storage of media
400—loading/unloading platen
500—recording units

In all drawings of the multiple picker assembly 100:
1—picker ‘n’
2—picker ‘n-1’
3—release spring for 1
4—release spring for 2
5—actuator for 1
6—actuator for 2
7—stack shaft
8—roll pin
9—media flag
10—sensor ‘n-STACK FULL’
11—sensor ‘LAST/EMPTY’
12—spring for 9

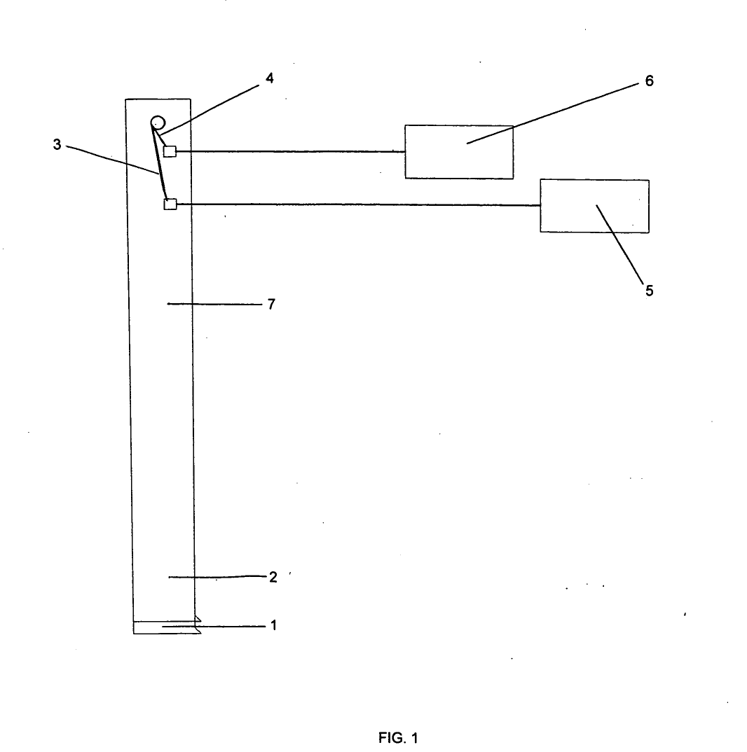

The invention, the multiple picker assembly 100, showed in FIG. 1 to FIG. 6 consists in the axial mounting of 2 retain-release mechanisms, one in the top of the other as functionality, creating a double retain-release mechanism, able to handle a stack of ‘n’ media.

The primary retain-release mechanism 1 is used to retain or release all ‘x’ stack of media, and the secondary retain-release mechanism 2 used to retain or release the ‘x-1’ stack of media, both as needed.

Combined use of this double mechanism, in certain sequences, allows the handling of ‘x’, ‘x-1’ or one single media, as needed.

FIG. 1

The drawings are representing the main components of the multiple-media picker system. Picker 1 and picker 2 have each just one active gripper, the other are passive. Picker 1 is activated for retain by powering the actuator 5 ON, usually a solenoid; and deactivated for release by powering 5 OFF, helped by the spring 3.

Picker 2 is activated for retain by powering 6 ON; and deactivated for release by powering 6 OFF, helped by the spring or other elastic assembly 4.

As observed, 1 is longer than 2, and 1 being designed to retain ‘n’ media, and 2 being designed to retain ‘n-1’ media.

The length of the stack-shaft 7, actually the length of 1, is usually ‘n’ times the thickness of the media.

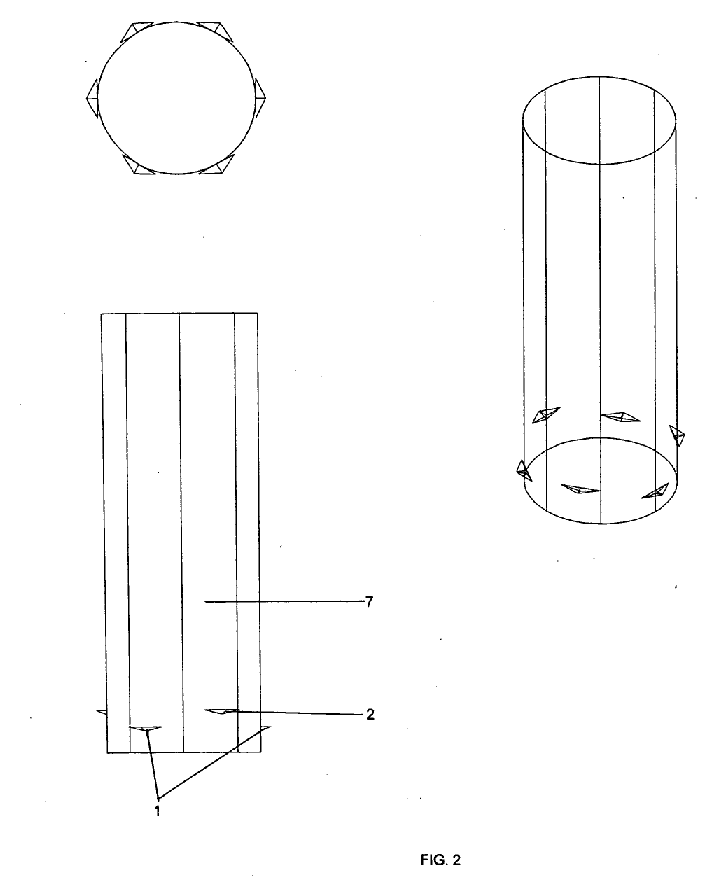

FIG. 2

The drawings are representing the internal picker in a different version from FIG. 1. Picker 1 and picker 2 have each at least 3 active grippers, but like at FIG. 1, placed at the ‘n’ and ‘n-1’ position counted from the accessing side of the stack.

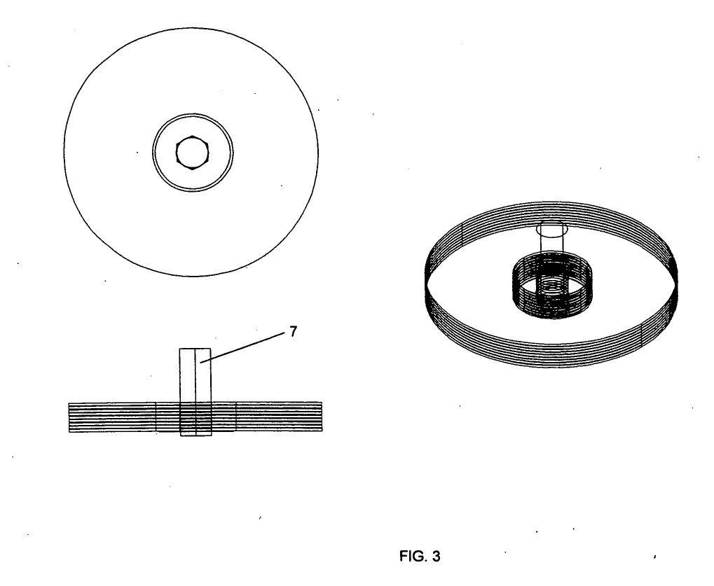

FIG. 3

It is representing the internal picker system with the stack shaft 7 and the number of ‘x’ media.

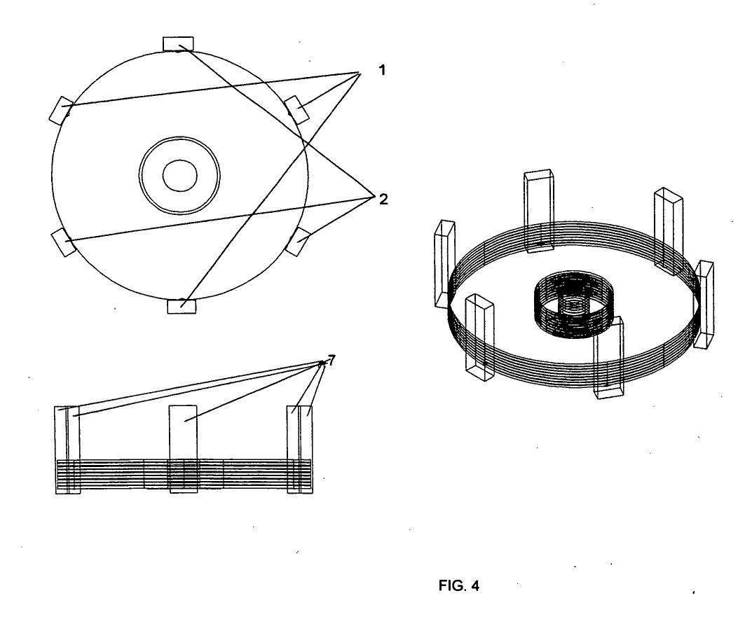

FIG. 4

It is representing an external picker system, in a 6×1 configuration, where there are 6 external arms, each one with 1 gripper. The arms are working simultaneously in 2 configurations of 3, one group of 3 having grippers for level ‘n’ and the other group of 3 having grippers for level ‘n-1’. Each group of 3 is arranged into a 120 degree circular position.

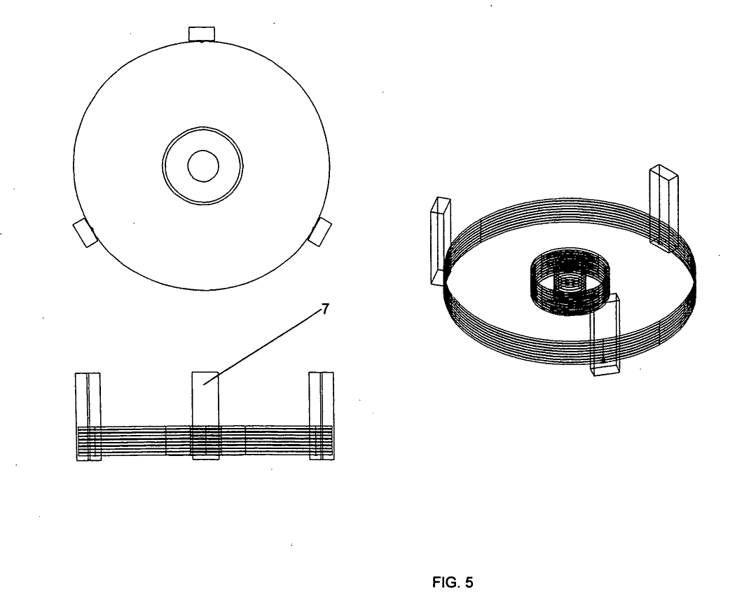

FIG. 5

It is representing an external picker system, in a 3×2 configuration, where there are 3 external arms, each with 2 grippers. The arms are mounted into a 120 degree circular position. The grippers are at level ‘n’ and ‘n-1’ on each arm.

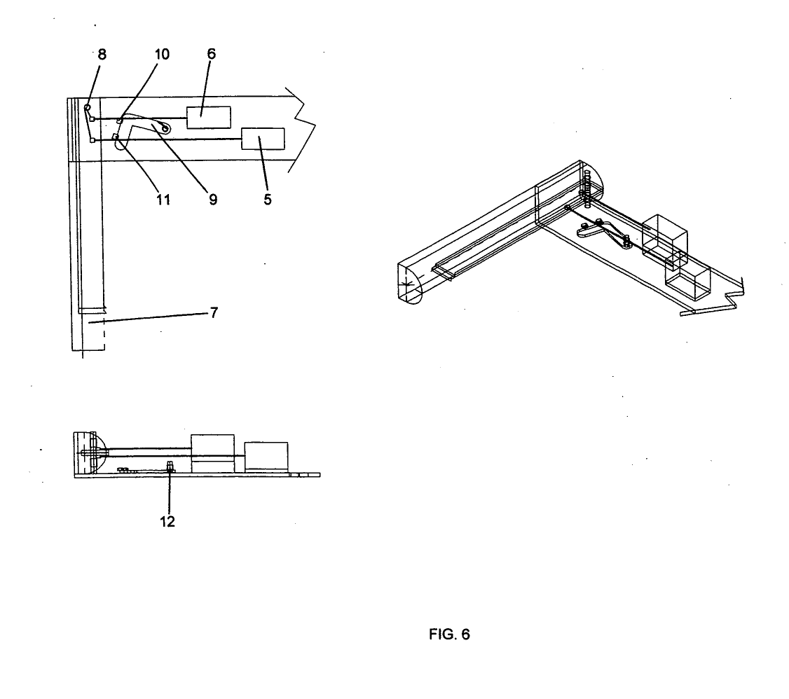

FIG. 6

It is a more detailed representation of FIG. 1, used also at the description of an application of the invention. The media flag 9 is switching the proximity sensors 10 and 11, sensing the presence of the media, usually in ‘STACK FULL’ and ‘LAST/EMPTY’ media position.

On 9 it can be mounted a spring 12, to pull it down, for a more reliable functionality. Also, that spring 12 together with the flag 9, can help the advance of the media on the stack-shaft, as a pusher, during a machine-cycle.

FIG. 7

It is a system drawing of use of a multiple picker system in a CD/DVD recording robot. The picker 100 is moving up and down on the tower 200, which is able to turn around its own vertical axis, making possible the accessing of 300, the input/output bins, which are storing the unprocessed and already processed media.

It is also possible to access the loading platen 400, which is making the discharge of the processed media and load of the unprocessed media into the processing/recording units 500.

Once the recording drives closed, the tower-picker assembly can proceed with the discharge of the recorded media from the output column of the platen 400 into the output bins 300 and reloading of the input column of the platen 400 from the input bins 300.

During a complete machine cycle, the multi-media picker system has to be able to perform as described in the ‘SUMMARY OF INVENTION’ and as follows:
1. To clear the recording or any other type of processing units, picker empty, no media on stack shaft 7, sensors 10 and 11 OFF. Picker 1 and picker 2 OFF both. Go to open tray, advance 7 thru media, and activate 2. Optionally, 1 can be activated too. Picker clear tray, close tray, picker go to next tray, approach media—advance into position ‘n’, release picker 2—actually drop media stack on top of ‘n’ position, lower picker and activate picker 2. Picker clear tray. Repeat, until flag 9 first hits sensor 10—stack full with n-1 media. For last media—‘n’ —keep picker 2 ON, use only picker 1 to pick up the last media. So, picker 2 is retaining ‘n-1’ media and picker 1 is retaining the last ‘n’ media.
2. To release the recorded media, the picker goes to the output bin and turn picker 1 and picker 2 OFF. The recorded media can be released also one by one, as described at step 4.
3. To pick up ‘n’ recordable media: picker empty, sensors 10 and 11 off, picker 1 and 2 off. Picker goes to input bin. Picker advances 7 thru stack of recordable media, until flag 9 hits sensor 10. Picker 1 and 2 ON. Stack of ‘n’ media loaded on the picker. Go to trays or any other processing units.
4. To fill up each processing unit with one media: go to the first unit, release picker 1 (OFF). Media ‘n’ in place, clear unit, close unit, go to next unit. Picker 1 ON, picker 2 OFF. As a result of this, the stack of ‘n-1’ media advances (drops) one position. It is helped also by flag 9 and spring 12, working as a pusher. Picker 2 ON. Picker 1 has been filled up and the picker system armed again. Keeping picker 2 ON, we can load the media from picker 1 into the next processing unit.
5. If necessary, keeping picker 2 ON and using it as a limit stopper, picker 1 can handle one single media, as needed, independently from the status of the stack-shaft.

The machine and the machine cycle from above are not strictly defined, it is just an example.

It should be understood that the invention is not intended to be limited by the specifics of the above described embodiment, but rather defined by the operating principles.

1. An apparatus for picking up one or more than one, up to ‘n’ flat work pieces individually or from a stack of work pieces, comprising:
an internal stack shaft vertically disposed and having a proximate end coupled to the support frame and a distal end extending downwardly from the support frame, said stack shaft having a smooth surface and an external diameter not larger than the hub of a top work piece, and/or
an external stack shaft having a plurality of members vertically disposed and having a proximate end coupled to the support frame and a distal end extending downwardly from the support frame, said members being spaced apart from each other sufficiently to contact different points on a perimeter of a top work piece
a plurality of retain-release mechanisms for picking and holding only one work piece each.

2. The apparatus of claim 1, wherein the plurality of members of the said external stack shaft are disposed in opposition to each other to form a triangle or a hexagon.

3. The apparatus of claim 1, wherein the length of the said stack shaft is sufficient to hold a number of ‘n’ work pieces.

4. The apparatus of claim 1, wherein the said retain-release mechanisms are mounted perpendicularly to the axis of the said stack shaft on the distal end, adjacently to each other.

5. The apparatus of claim 1, wherein the upper work pieces on the said stack shaft are directly supported by the work pieces ‘n’ and/or ‘n-1’ at the distal end of the said stack shaft.

6. The apparatus of claim 1, wherein the said work pieces ‘n’ and ‘n-1’ at the distal end of the said stack shaft are held and released by said retain-release mechanisms.

7. The apparatus of claim 1, wherein the said retain release mechanisms are engaged and released alternatively and/or simultaneously controlling the relative movement of the work pieces on the said stack shaft.
